(19) United States
(12) Patent Application Publication
(10) Pub. No.: US 2002/0046108 A1
(43) Pub. Date: Apr. 18, 2002

(54) Web attract loop

(76) Inventors: Arthur Ernest Conrad, Fairfield, CT (US); Gregory J. Decker, Mount Holly, VT (US); Joseph F. Celano, Killingworth, CT (US)

Correspondence Address: ST. ONGE STEWARD JOHNSTON & REENS, LLC, 986 BEDFORD STREET, STAMFORD, CT, 06905-5619, US

(21) Appl. No.: 09/903,976

(22) Filed: Jul. 12, 2001

Related U.S. Application Data
(60) Provisional application No. 60/217,800, filed on Jul. 12, 2000.

(51) Int. Cl. G06F 17/60

(52) U.S. Cl. 705/14

(57) ABSTRACT

A system for displaying a web attract loop on a display of a user computer is provided. The system includes a central computer with software executing thereon for receiving a request to transmit a web page and for transmitting a web page to the user computer in response to the request to transmit the web page. The web page includes attract loop code which monitors the user computer for a user event, and if the user event does not occur within a specified time period, the attract loop code automatically transmits a request for attract loop content to the central computer. Software executing on the central computer automatically transmits attract loop content to the user computer in response to the request for attract loop content, and the attract loop code causes the attract loop content to be displayed on the display of the user computer.

### RELATED APPLICATIONS

The present invention claims the benefit of, under 35 U.S.C. §119(e), U.S. Provisional Patent Application No. 60/217,800, filed Jul. 12, 2000.

### FIELD OF THE INVENTION

The present invention relates to a web attract loop for automatically displaying web content after detection of an idle period of predetermined duration, or in other words, a screen saver which displays web-based content.

### BACKGROUND OF THE INVENTION

Screen savers, which have been in existence since the mid-1980's, are now in widespread use to prevent the premature degradation of CRT or liquid crystal displays as can occur if the same image remains displayed for too long, as is well known in the art. Screen savers operate in a background mode monitoring the input to the system, and once a predetermined time has elapsed since the last input, switch to a foreground mode in which they continuously alter the screen display so that it “saves” the screen, and may additionally function to hide or obscure what the user has displayed on his or her computer.

Typically, screen savers have comprised programs which reside in the system software and which include a prestored multi-media presentation which comes onto the screen after a prescribed period of non-usage by the user. Although screen savers have long been available for download via communication links (such as the Internet), such screen savers have traditionally required that a user specifically request to download the program, and then once downloaded, have required that the user install the application on his/her computer. Thus, with traditional screen savers, it was not possible to vary the content of a screen saver without the user specifically requesting to download screen saver media and installing the downloaded media on his/her computer. This is disadvantageous in that the downloading and installation process can be onerous, particularly for users who are not computer-savvy. Moreover, using traditional screen savers, it was not possible for a third party to display a screen saver at all on a user's computer without the user specifically downloading and installing the application in the first place. Such is disadvantageous, particularly in the context of advertising, in that third parties could not cause a screen saver to be displayed without the active intervention of the user. As will be understood by those skilled in advertising, such an active role by a potential target for the advertising is seldom effective.

A number of systems have been developed which attempt to improve upon the traditional screen saver. One of such systems is the PointCast® Network, which “broadcasts” personalized news to Internet users, and which also allows advertisers to deliver advertisements directly to Internet users. The advertisements delivered by the PointCast® Network appear on the user's computer when the computer is running the PointCast® Network application software. The application software has a “screen saver” mode in which the application displays advertisements on the user's computer in a random fashion, thereby allowing the operators of the PointCast® Network to control the media which is displayed on the screen saver without requiring the user to specifically download and install new media. However, such can only occur if the user specifically downloads and installs the PointCast® Network application software, and if the software is currently running. As such, there is no way for a third party (i.e., the PointCast® Network) to display a screen saver at all on a user's computer without the user specifically downloading and installing the application (i.e., PointCast® Network application software) in the first place.

U.S. Pat. No. 6,119,098 discloses a system similar to the PointCast® Network, but which includes a mechanism by which advertisements can be better targeted to each particular user. While the disclosed system does include a screen saver mode, the content of which may be varied without user intervention, like the PointCast® Network, the system requires the user to download and install the application software himself/herself before the screen saver can be activated. As such, the system disclosed in U.S. Pat. No. 6,119,098 suffers from disadvantages similar to those discussed above with respect to the PointCast® Network.

What is desired, therefore, is a web attract loop which automatically displays web content after detection of an idle period of predetermined duration, which can be downloaded without user intervention, which does not require user installation on a user computer, and which includes media which can be modified by a third party without user intervention.

### SUMMARY OF THE INVENTION

Accordingly, it is an object of the present invention to provide a web attract loop which automatically displays web content after detection of an idle period of predetermined duration.

Another object of the present invention is to provide a web attract loop having the above characteristics and which can be downloaded without user intervention.

A further object of the present invention is to provide a web attract loop having the above characteristics and which does not require user installation on a user computer.

Still another object of the present invention is to provide a web attract loop having the above characteristics and which includes media which can be modified by a third party without user intervention.

These and other objects of the present invention are achieved by provision of a system for displaying a web attract loop on a display of a user computer. The system includes a central computer with software executing thereon for receiving a request to transmit a web page and for transmitting a web page to the user computer in response to the request to transmit a web page. The web page includes attract loop code which monitors the user computer for a user event, and if the user event does not occur within a specified time period, the attract loop code automatically transmits a request for attract loop content to the central computer. Software executing on the central computer automatically transmits attract loop content to the user computer in response to the request for attract loop content, and the attract loop code causes the attract loop content to be displayed on the display of the user computer.

Preferably, while the attract loop content is being displayed on the display of the user computer, the attract loop code monitors the user computer for a user event, and, upon the occurrence of the user event, automatically causes the display of the attract loop content to be terminated. It is also preferable that the central computer comprise a web server.

The attract loop content may be displayed in a browser window. Optionally, the browser window may be in full screen mode and/or the browser window may be automatically opened by the attract loop code. Preferably, the attract loop code automatically causes the attract loop content to be continually updated.

The user event may be selected from the group consisting of manipulation of an input device, movement of a mouse, typing on a keyboard, access of a storage device, and combinations of these. The attract loop content may comprise text, graphics, animation, sound, video, multimedia, and combinations of these, and the attract loop content may relate to advertisement, entertainment, education, and combinations of these.

The invention and its particular features and advantages will become more apparent from the following detailed description considered with reference to the accompanying drawings.

### BRIEF DESCRIPTION OF THE DRAWINGS

FIG. 1 is a schematic view illustrating a web attract loop in accordance with the present invention; and

FIG. 2 is a flowchart illustrating in more detail operation of the web attract loop of FIG. 1.

### DETAILED DESCRIPTION OF THE INVENTION

The present invention introduces a novel concept for web-based content and the use of web-based content as a screen saver. A web attract loop according to the invention automatic displays compelling web content after detection of an idle period of predetermined duration for the purpose of engaging the attention of casual observers. When operation of the attract loop is terminated via computer user interaction, the user is returned to the state of the primary interaction that existed when operation of the attract loop began. The content of the attract loop may take any form possible within the context of computer based system including text, graphics, animations, sound, and multimedia.

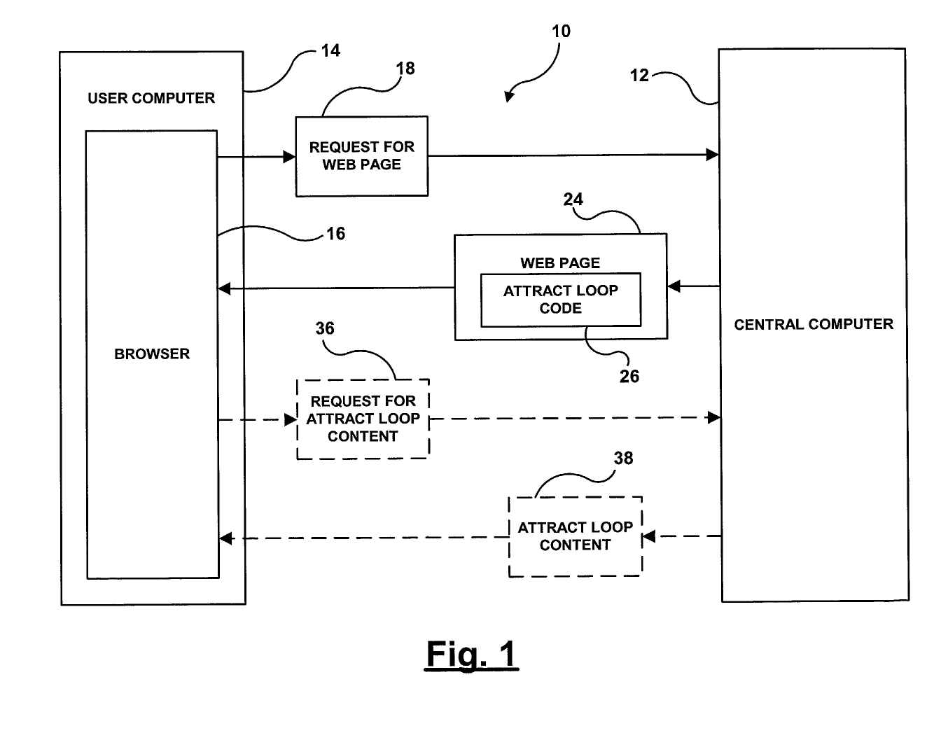

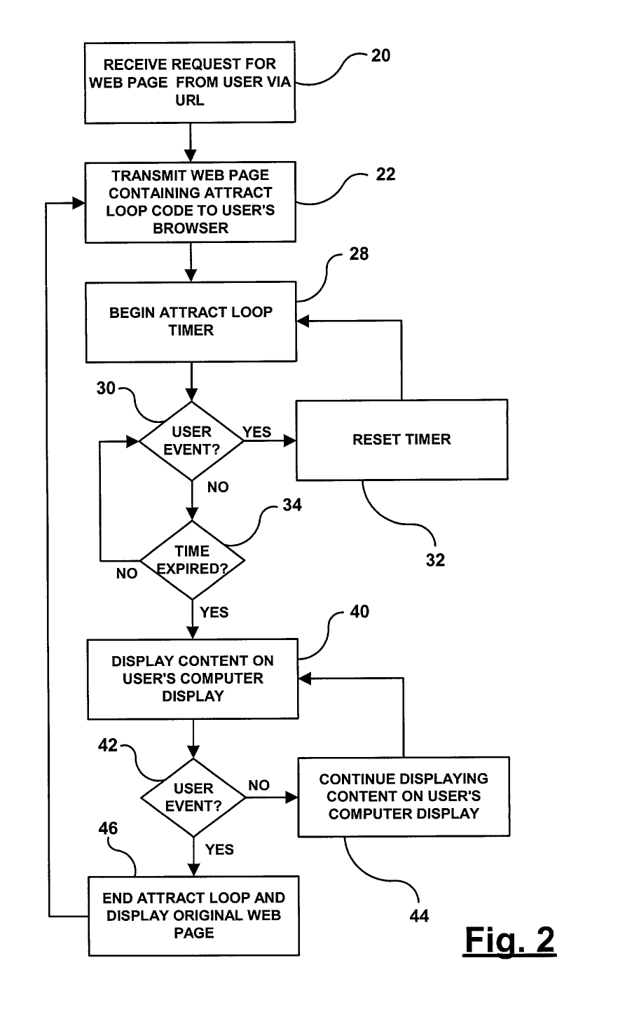

Referring to FIGS. 1 and 2, a web attract loop system 10 in accordance with the present invention is shown. The system 10 includes a central computer 12 and at least one user computer 14 in communication with central computer 12 by way of a communications link. The communications link may comprise any type of communications link, either wired or wireless, such as, for example, the Internet, a local area network (LAN), a wide area network (WAN), a direct modem link, a virtual private network (VPN), or the like. It should be understood that when the term “network” is used herein, what is meant is any means, whether wired or wireless, by which a signal may be transmitted from one device to another. Central computer 12 may comprise a single computer, or a network of computers, and may comprise one or more web servers, or other types of servers, it being understood that central computer 12 is not limited to any particular configuration. Similarly, user computer 14 may comprise a single computer, or a network of computers, it being understood that user computer 14 is not limited to any particular configuration. The only requirement for user computer 14 is that user computer 14 include some sort of display, which may take the form of a CRT monitor, although such it not required.

Executing on user computer 14 is a web browser 16, such as by way of illustration but not limitation, Microsoft® Internet Explorer or Netscape® browsers. It should be understood that when the term “browser” is used herein, what is meant is any software application by which a web page may be received and viewed.

Browser 16 is used to transmit a request 18 for a web page to central computer 12, typically, although not necessarily, through the specification of a uniform resource locator (URL). Central computer 12 receives request 18 at step 20, and at step 22 transmits a web page 24 to browser 16 executing on user computer 14. Web page 24 includes attract loop code 26, which may be written, for example, in VBscript. As will be readily appreciated by those skilled in the art, however, attract loop code 26 may be written in any of a number of known or yet to be implemented languages. Web page 24 typically comprises a hypertext markup language (HTML) document, although such is not strictly required, which may or may not include applications and/or scripts in addition to attract loop code 26.

Attract loop code 26, executing on browser 16, begins an attract loop timer at 28 to determine whether a user event being monitored occurs on user computer 14 within a specified time period. The user event which is being monitored may comprise by way of illustration and not limitation, the manipulation of an input device, such as movement of a mouse, typing on a keyboard, or the like, access of a storage device, such as a hard drive, or any of a number of other events as is known in the art. The specified time period may be determined and set by an operator of central computer 12, and may, for example, be measured in seconds, minutes, hours, etc.

As illustrated at 30, if the user event or events which are being monitored occur, the attract loop timer is reset (illustrated at 32), and monitoring for the user event or events resumes. If the user event or events have not occurred, the attract loop timer determines, as illustrated at 34, whether the specified time period has expired. If it has not so expired, attract loop timer continues to monitor for the user event or events. If, however, the specified time period has expired, attract loop code 26 causes browser 16 to transmit a request 36 for attract loop content to central computer 12, in response to which in central computer 12 transmits attract loop content 38 to browser 16. Attract loop code 26 causes the received attract loop content 38 to be displayed on the display of user computer 14, as illustrated at step 40.

Attract loop content 38 may comprise substantially any form of content, such as by way of illustration and not limitation, text, graphics, animation, sound, video, multimedia, substantially any other form of visual, auditory and/or olfactory content, and combinations of these. Moreover, it should be understood that attract loop content 38 may relate to substantially any subject matter and/or serve substantially any purpose, such as by way of illustration and not limitation, advertisement, entertainment, education, or the like. Moreover, it should also be understood that attract loop code may continually causes browser 16 to transmit requests 36 for new attract loop content, such that attract loop content 38 may be continually updated over time.

Attract loop content 38 may be displayed on the user computer's display by any of numerous means. For example, attract loop content 38 may be displayed in the open window of browser 16 through which request 18 for web page had originally been transmitted. Optionally, the open window of browser 16 may be caused to enter a full screen mode before attract loop content 38 is displayed, whereby the appearance of a traditional screen saver can be accomplished. Alternately, attract loop code 26 may cause a new browser window to be opened, either as a window or in full screen mode, and cause attract loop content 38 to be displayed therein.

As attract loop content 38 is being displayed, attract loop code 26 continues to monitor for the occurrence of the user event or events (illustrated at 42). If the user event or events do not occur, attract loop code 26, as illustrated at 44, continues to display attract loop content and continues to monitor for the user event or events. If, however, the user event or events do occur, attract loop code 26, as illustrated at 46, ends the attract loop and displays the original web page 24. If an additional browser window was opened in which to display attract loop content, it may be closed. Moreover, if the existing browser window was caused to enter a full screen mode, attract loop code 26 may cause it to return to window mode.

The present invention, therefore, provides a web attract loop which automatically displays web content after detection of an idle period of predetermined duration, which can be downloaded without user intervention, which does not require user installation on a user computer, and which includes media which can be modified by a third party without user intervention.

Although the invention has been described with reference to a particular arrangement of parts, features and the like, these are not intended to exhaust all possible arrangements or features, and indeed many other modifications and variations will be ascertainable to those of skill in the art.

What is claimed is:

1. A system for displaying a web content on a display of a user computer, said system comprising:
a central computer;
software executing on said central computer for receiving a request to transmit a web page;
software executing on said central computer for transmitting a web page to the user computer in response to the request to transmit a web page, the web page comprising attract loop code, wherein the attract loop code monitors the user computer for a user event, and if the user event does not occur within a specified time period, the attract loop code automatically transmits a request for attract loop content to said central computer;
software executing on said central computer for automatically transmitting attract loop content to the user computer in response to the request for attract loop content; and
wherein the attract loop code causes the attract loop content to be displayed on the display of the user computer.

2. The system of claim 1 wherein the attract loop code, while the attract loop content is being displayed on the display of the user computer, monitors the user computer for a user event, and, upon the occurrence of the user event, automatically causes the display of the attract loop content to be terminated.

3. The system of claim 1 wherein said central computer comprises a web server.

4. The system of claim 1 wherein the attract loop content is displayed in a browser window.

5. The system of claim 4 wherein the attract loop content is displayed in a browser window in full screen mode.

6. The system of claim 4 wherein the attract loop content is displayed in a browser window which was automatically opened by the attract loop code.

7. The system of claim 1 wherein the attract loop code automatically causes the attract loop content to be continually updated.

8. The system of claim 1 wherein the user event is selected from the group consisting of manipulation of an input device, movement of a mouse, typing on a keyboard, access of a storage device, and combinations of these.

9. The system of claim 1 wherein the attract loop content comprises media selected from the group consisting of text, graphics, animation, sound, video, multimedia, and combinations of these.

10. The system of claim 1 wherein the attract loop content relates to subject matter selected from the group consisting of advertisement, entertainment, education, and combinations of these.

11. A system for displaying web content on a display of a user computer, said system comprising:
a central computer;
software executing on said central computer for receiving, from a browser executing on the user computer, a request to transmit a web page;
software executing on said central computer for transmitting a web page to the browser executing on the user computer in response to the request to transmit a web page, the web page comprising attract loop code, wherein the attract loop code monitors the user computer for a user event, and if the user event does not occur within a specified time period, the attract loop code causes the browser executing on the user computer to transmit a request for attract loop content to said central computer;
software executing on said central computer for transmitting attract loop content to the browser executing on the user computer in response to the request for attract loop content; and
wherein the attract loop code causes the attract loop content to be displayed on the display of the user computer through the browser.

12. The system of claim 11 wherein the attract loop code, while the attract loop content is being displayed on the display of the user computer, monitors the user computer for a user event, and, upon the occurrence of the user event, automatically causes the display of the attract loop content to be terminated.

13. The system of claim 11 wherein said central computer comprises a web server.

14. The system of claim 11 wherein the attract loop content is displayed in a browser window.

15. The system of claim 14 wherein the attract loop content is displayed in a browser window in full screen mode.

16. The system of claim 14 wherein the attract loop content is displayed in a browser window which was automatically opened by the attract loop code.

17. The system of claim 11 wherein the attract loop code automatically causes the attract loop content to be continually updated.

18. The system of claim 11 wherein the user event is selected from the group consisting of manipulation of an input device, movement of a mouse, typing on a keyboard, access of a storage device, and combinations of these.

19. The system of claim 11 wherein the attract loop content comprises media selected from the group consisting of text, graphics, animation, sound, video, multimedia, and combinations of these.

20. The system of claim 11 wherein the attract loop content relates to subject matter selected from the group consisting of advertisement, entertainment, education, and combinations of these.

21. A system for implementing an attract loop, said system comprising:
a central computer;
a user computer in communication with said central computer through a communications link, said user computer having a browser executing thereon and having a display;
software executing on said central computer for receiving, from the browser executing on said user computer, a request to transmit a web page;
software executing on said central computer for transmitting a web page to the browser executing on said user computer in response to the request to transmit a web page, the web page comprising attract loop code, wherein the attract loop code monitors said user computer for a user event, and if the user event does not occur within a specified time period, the attract loop code causes the browser executing on said user computer to transmit a request for attract loop content to said central computer;
software executing on said central computer for transmitting attract loop content to the browser executing on said user computer in response to the request for attract loop content; and
wherein the attract loop code causes the attract loop content to be displayed on the display of said user computer through the browser.

22. A system for displaying web content on a display of a user computer, said system comprising:
a central computer;
software executing on said central computer for receiving a request to transmit a web page; and
software executing on said central computer for transmitting a web page to the user computer in response to the request to transmit a web page, the web page comprising attract loop code and attract loop content, wherein the attract loop code monitors the user computer for a user event, and if the user event does not occur within a specified time period, the attract loop code automatically causes the attract loop content to be displayed on the display of the user computer.

23. A method for displaying web content on a display of a user computer, said method comprising the steps of:
providing a central computer;
receiving a request to transmit a web page;
transmitting a web page to the user computer in response to the request to transmit a web page, the web page comprising attract loop code, wherein the attract loop code monitors the user computer for a user event, and if the user event does not occur within a specified time period, the attract loop code automatically transmits a request for attract loop content to the central computer;
automatically transmitting attract loop content to the user computer in response to the request for attract loop content; and
wherein the attract loop code causes the attract loop content to be displayed on the display of the user computer.

24. The method of claim 23 wherein the attract loop code, while the attract loop content is being displayed on the display of the user computer, monitors the user computer for a user event, and, upon the occurrence of the user event, automatically causes the display of the attract loop content to be terminated.

25. The method of claim 23 wherein the central computer comprises a web server.

26. The method of claim 23 wherein the attract loop content is displayed in a browser window.

27. The method of claim 26 wherein the attract loop content is displayed in a browser window in full screen mode.

28. The method of claim 26 wherein the attract loop content is displayed in a browser window which was automatically opened by the attract loop code.

29. The method of claim 23 wherein the attract loop code automatically causes the attract loop content to be continually updated.

30. The method of claim 23 wherein the user event is selected from the group consisting of manipulation of an input device, movement of a mouse, typing on a keyboard, access of a storage device, and combinations of these.

31. The system of claim 23 wherein the attract loop content comprises media selected from the group consisting of text, graphics, animation, sound, video, multimedia, and combinations of these.

32. The method of claim 23 wherein the attract loop content relates to subject matter selected from the group consisting of advertisement, entertainment, education, and combinations of these.

33. A method for displaying web content on a display of a user computer, said method comprising the steps of:
providing a central computer;
receiving, from a browser executing on the user computer, a request to transmit a web page;
transmitting a web page to the browser executing on the user computer in response to the request to transmit a web page, the web page comprising attract loop code, wherein the attract loop code monitors the user computer for a user event, and if the user event does not occur within a specified time period, the attract loop code causes the browser executing on the user computer to transmit a request for attract loop content to the central computer;
transmitting attract loop content to the browser executing on the user computer in response to the request for attract loop content; and
wherein the attract loop code causes the attract loop content to be displayed on the display of the user computer through the browser.

34. The method of claim 33 wherein the attract loop code, while the attract loop content is being displayed on the display of the user computer, monitors the user computer for a user event, and, upon the occurrence of the user event, automatically causes the display of the attract loop content to be terminated.

35. The method of claim 33 wherein the central computer comprises a web server.

36. The method of claim 33 wherein the attract loop content is displayed in a browser window.

37. The method of claim 36 wherein the attract loop content is displayed in a browser window in full screen mode.

38. The method of claim 36 wherein the attract loop content is displayed in a browser window which was automatically opened by the attract loop code.

39. The method of claim 33 wherein the attract loop code automatically causes the attract loop content to be continually updated.

40. The method of claim 33 wherein the user event is selected from the group consisting of manipulation of an input device, movement of a mouse, typing on a keyboard, access of a storage device, and combinations of these.

41. The method of claim 33 wherein the attract loop content comprises media selected from the group consisting of text, graphics, animation, sound, video, multimedia, and combinations of these.

42. The method of claim 33 wherein the attract loop content relates to subject matter selected from the group consisting of advertisement, entertainment, education, and combinations of these.

43. A method for implementing an attract loop, said method comprising the steps of:
providing a central computer;
providing a user computer in communication with said central computer through a communications link, the user computer having a browser executing thereon and having a display;
receiving, from the browser executing on the user computer, a request to transmit a web page;
transmitting a web page to the browser executing on the user computer in response to the request to transmit a web page, the web page comprising attract loop code, wherein the attract loop code monitors said user computer for a user event, and if the user event does not occur within a specified time period, the attract loop code causes the browser executing on the user computer to transmit a request for attract loop content to the central computer;
transmitting attract loop content to the browser executing on the user computer in response to the request for attract loop content; and
wherein the attract loop code causes the attract loop content to be displayed on the display of the user computer through the browser.

44. A method for displaying web content on a display of a user computer, said method comprising the steps of:
receiving a request to transmit a web page; and
transmitting a web page to the user computer in response to the request to transmit a web page, the web page comprising attract loop code and attract loop content, wherein the attract loop code monitors the user computer for a user event, and if the user event does not occur within a specified time period, the attract loop code automatically causes the attract loop content to be displayed on the display of the user computer.
